(19) United States
(12) Patent Application Publication
(10) Pub. No.: US 2004/0181326 A1
(43) Pub. Date: Sep. 16, 2004

(54) Network-Based Home Vehicular Management

(76) Inventors: Thomas Lee Adams, Austin, TX (US); James M. Doherty, Georgetown, TX (US)

Correspondence Address: LACASSE & ASSOCIATES, LLC, 1725 DUKE STREET, SUITE 650, ALEXANDRIA, VA, 22314, US

(21) Appl. No.: 10/249,088

(22) Filed: Mar. 14, 2003

(51) Int. Cl. G06F 19/00

(52) U.S. Cl. 701/35; 701/213

(57) ABSTRACT

A fixed wireless network is defined by a home gateway communicating with a network interface device located in vehicles within a fixed predefined area. The network interface devices enable the transfer of vehicle location related measurements to the home gateway when the vehicle is within the fixed predefined area. When the vehicle roams outside the predefined area, measurements are obtained by an in-vehicle Global Positioning System (GPS). The obtained measurements are then uploaded from the logging database to the home gateway using the network interface devices when the vehicle returns to the fixed predefined area. The measurements can further be uploaded from the home gateway to a network-based service location system. The measurement may include maintenance, speed, or vehicle usage information.

### BACKGROUND OF INVENTION

1. Field of Invention

The present invention relates generally to the field of wireless communications. More specifically, the present invention is related to electronic record keeping.

2. Discussion of Prior Art

One popular method of implementing a wireless connection is based upon the IEEE 802.11 standard. 802.11 refers to a family of specifications developed by the Institute of Electrical and Electronics Engineers (IEEE) for wireless local area network (LAN) technology. 802.11 specifies an over-the-air interface between a wireless client and a base station or between two wireless clients. There are several specifications in the 802.11 family, some of which are described below:

802.11 applies to wireless LANs providing 1 or 2 Mbps transmission in the 2.4 GHz band using either frequency hopping spread spectrum (FHSS) or direct sequence spread spectrum (DSSS).

802.11a an extension to 802.11 that applies to wireless local area networks (LANs) and provides up to 54 Mbps in the 5 GHz band. 802.11a uses an orthogonal frequency division multiplexing encoding scheme rather than FHSS or DSSS.

802.11b also referred to as 802.11 High rate or Wi-Fi (for wireless fidelity), formed as a ratification to the original 802.11 standard, allowing wireless functionality comparable to the Ethernet. This is an extension to 802.11 that applies to wireless LANs and provides 11 Mbps transmission (with fallback to 5.5, 2, and 1 Mbps) in the 2.4 GHz band. Transmission in the 802.11b standard is accomplished via DSSS.

802.11 g applies to wireless LANs and provides 20+ Mbps in the 2.4 GHz band.

The most popular of the above standards is the 802.11b.

The following references provide for a brief description of GPS data gathering techniques, but it should be noted that the prior art fails to provide for, either directly or indirectly, the teachings and implementations of the system and method of the present invention.

The patent to Wang et al. (5,365,451), assigned to Motorola, Inc., provides for a mobile unit tracking system. Described within is a mobile communication system where mobile units are capable of reporting their locations to a central control system.

The patent to Barzegar et al. (5,559,520), assigned to Lucent Technologies Inc., provides for a wireless information system for acquiring location related information. Described within is an in-vehicle monitoring system for storing GPS related measurements.

The patents to Hagenbuch (5,742,914) and Keith et al. (6,393,346 B1), and the patent application publication to Schick et al. (2002/0065698 A1) describe a method for reporting position information in a vehicle to a central location.

The patent to Fraker et al. (5,919,239) provides for a position and time-at-position logging system. Discussed within is a logging system that stores a plurality of GPS obtained measurements and transmits the measurements to a central location for processing.

The patent to Chigumira, et al. (6,088,636) provides for a vehicle trip data computer. Discussed within is an in-vehicle trip recorder system that stores a plurality of measurements related to the vehicle in movement.

The patent to Solomon et al. (6,408,233 B1), assigned to Axiom Navigation, Inc., provides for a GPS data logger with automatic wireless download. Described within is an in-vehicle monitoring system for storing GPS generated measurements in a storage device within a vehicle, and for downloading the stored measurements to a remote device over a cellular network.

The patent application publication to Obata et al. (2002/0123840 A1), assigned to Hitachi, Ltd., provides for uploading and managing vehicle position information. Described within is a method for reporting the position of mobile vehicle to a central control system.

The non-patent literature entitled “TripTracer” describes an in-vehicle GPS data collection system that stores vehicle trip information and that is capable of uploading the stored information to a PC through a USB interface. However, there is no mention of a wireless download system.

Whatever the precise merits, features and advantages of the above cited references, none of them achieves or fulfills the purposes of the present invention.

### SUMMARY OF THE INVENTION

The present invention provides for a network-based home vehicular management system (located within a vehicle), wherein the system comprises a global positioning system (GPS) for identifying location information, a data logger that is operatively linked with the GPS, and a wireless network interface capable of communicating with at least one gateway via a protocol such as the IEEE 802.11b protocol. The data logger periodically collects and stores location information when the home vehicular management system is outside of a fixed wireless network coverage area. The wireless network interface is capable of transmitting the stored location information to the gateway, wherein the transmission is triggered when the home vehicular management system is within the fixed wireless network coverage area. The gateway forwards the location information to a network-based service location, and the service location utilizes the received location information to offer various historical vehicular position services.

The historical vehicular position services offered by the service location comprises any of (but should not be limited to) the following: notifications regarding maximum speed exceptions, notifications regarding acceptable routes or destinations, notifications of preventive maintenance, or tax oriented record keeping services.

Additionally, communications between the gateway and the network-based service location are envisioned to be performed over any of the following networks: local area network (LAN), wide area network (WAN), wireless network, or the Internet.

The present invention also provides for a method for receiving historical vehicular position services, wherein the method comprises the steps of: (a) identifying when a vehicle enters a fixed network coverage area, wherein the vehicle is equipped with a global positioning system (GPS) for identifying location information, a logging system for periodically collecting and storing location information, and a wireless network interface for communicating via a protocol such as the IEEE 802.11b protocol; (b) establishing a wireless communication link with a network interface when the vehicle is within the fixed network coverage area; (c) wirelessly receiving the stored location information; (d) forwarding the wirelessly received location information to a service location over a network, the service location identifying historical vehicular position services based upon the received location information; and (e) receiving the identified historical vehicular position services.

### BRIEF DESCRIPTION OF DRAWINGS

FIG. 1 illustrates a general architecture of the preferred embodiment of the present invention.

FIG. 2 illustrates a method associated with the preferred embodiment of the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

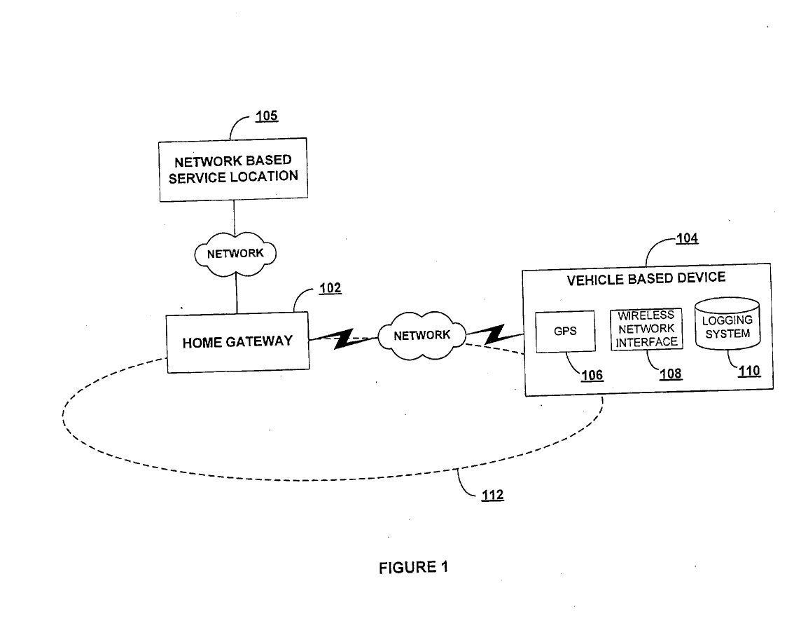

FIG. 1 illustrates the general architecture of the present invention, wherein the architecture comprises a home wireless home gateway device 102 in communication with a vehicle-based system 104, and a network based service location 105. The vehicle-based system further comprises a Global Positioning System (GPS) 106, a wireless network interface 108 (compatible with the home gateway device 102), and a logging system 110 capable of collecting and uploading GPS position information. The area enclosed by 112 defines (simply for the purposes of this example) the network coverage area within which the home gateway device 102 is able to communicate wirelessly with the network interface 108 of the vehicle-based system 104.

One scenario involves a vehicle that is initially located within the fixed network coverage area 112, but is departing that area. While outside the coverage area 112, the GPS 106 and logging system 110 within the vehicle collects and stores periodic time and location information, a function commonly available in GPS systems. When the vehicle is within the fixed wireless network coverage area 112, wireless network connectivity is established (between the home gateway 102 and vehicle-based device 104), via a protocol such as the IEEE 802.11 b protocol, and the vehicle's stored route information (stored in logging system 110) is uploaded via the home gateway 102 and it's associated public network connectivity (e.g., dial-up or broadband) into the network-based service location 105.

Once the route information is available at the network-based service location 105, historical vehicular position services may be offered to the home gateway subscriber. These services could include (but are not limited to) notifications regarding vehicle usage, such as maximum speed exceptions, acceptable route, destination exception, or a simple record of routes and destinations. Additional vehicular mileage-based services envisioned include (but are not limited to): notification of required preventive maintenance, tax oriented record keeping services, or in conjunction with an additional subscriber input regarding trip purposes. It is also envisioned that the disclosed invention can be used in record keeping (such maintenance is done in prior art using paper records) for providing an electronic means for reviewing the travel.

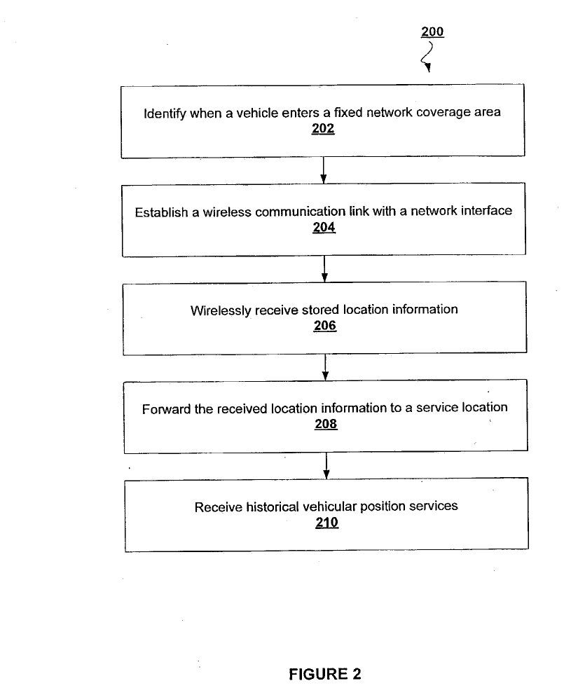

FIG. 2 illustrates a method 200 associated with the preferred embodiment of the present invention. In step 202, an identification is made when a vehicle enters a fixed network coverage area (i.e., 112 of FIG. 1). The vehicle, as in FIG. 1, is equipped with a GPS unit for identifying location information, a logging system for periodically collecting and storing location information, and a wireless network interface for communicating via a wireless protocol such as the IEEE 802.11b protocol. In step 204, when the vehicle is within the fixed network coverage area, a wireless communication link is established between the gateway and the wireless network interface. In step 206, location information stored in the logging system is received wirelessly by the gateway, which, in step 208, forwards the location information to a service location over a network. The service location identifies historical vehicular position services based upon the received location information. Finally, in step 210, historical vehicular position services are received by a computing device operatively linked with the gateway.

### CONCLUSION

A system and method has been shown in the above embodiments for the effective implementation of a network-based home vehicular management. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by the type of service offered at the network-based service location, the type of network over which the home gateway and network based service location communicate, specific home gateway hardware, radius of fixed wireless network coverage area, or the type of storage used in the logging system.

The above enhancements are implemented in various networking environments. For example, communications between the home gateway device and the network-based service location may be over various networks, such as: a local area network (LAN), a wide area network (WAN), or the Internet.

1. A network-based home vehicular management system, said system comprising:
a. a global positioning system (GPS) identifying location information;
b. a data logger operatively linked with said GPS, said data logger periodically collecting and storing location information including when said home vehicular management system is outside a fixed wireless network coverage area; and
c. a wireless network interface, said wireless network interface capable of communicating with at least one gateway via the IEEE 802.11 b protocol to transmit said stored location information, said transmission triggered when said home vehicular management system is within said fixed wireless network coverage area,
whereby said transmitted stored location information is forwarded to a network-based service location via said gateway, said service location offering historical vehicular position services.

2. A network-based home vehicular management system, as per claim 1, wherein said historical vehicular position services comprises any of:
notifications regarding maximum speed exceptions, notifications regarding acceptable routes or destinations, notifications of preventive maintenance, or tax oriented record keeping services.

3. A network-based home vehicular management system, as per claim 1, wherein communications between said gateway and said network-based service location are over any of the following networks: local area network (LAN), wide area network (WAN), wireless network, or the Internet.

4. A method for receiving historical vehicular position services, said method comprising the steps of:
a. identifying when a vehicle enters a fixed network coverage area, said vehicle equipped with a global positioning system (GPS) for identifying location information, a logging system for periodically collecting and storing location information, and a wireless network interface for communicating via the IEEE 802.11b protocol;
b. establishing a wireless communication link with a network interface when said vehicle is within said fixed network coverage area;
c. wirelessly receiving said stored location information;
d. forwarding said wirelessly received location information to a service location over a network, said service location identifying historical vehicular position services based upon said received location information; and
e. receiving said identified historical vehicular position services.

5. A method for receiving historical vehicular position services, as per claim 4, wherein said historical vehicular position services comprises any of:
notifications regarding maximum speed exceptions, notifications regarding acceptable routes or destinations, notifications of preventive maintenance, or tax oriented record keeping services.

6. A method for receiving historical vehicular position services, as per claim 4, wherein said network is any of the following: local area network (LAN), wide area network (WAN), wireless network, or the Internet.

7. A method for receiving historical vehicular position services, said method comprising the steps of:
a. identifying when a vehicle enters a fixed network coverage area, said vehicle equipped with a global positioning system (GPS) for identifying location information, a logging system for periodically collecting and storing location information, and a wireless network interface for communicating via the IEEE 802.11 b protocol;
b. establishing a wireless communication link with a network interface when said vehicle is within said fixed network coverage area;
c. wirelessly receiving said stored location information;
d. forwarding said wirelessly received location information to a service location over the Internet, said service location identifying at least one historical vehicular position service based upon said received location information, said historical vehicular position service comprising any of: notification regarding maximum speed exceptions, notification regarding acceptable routes or destinations, notification of preventive maintenance, or tax oriented record keeping service; and
e. offering said identified historical vehicular position services.

8. A method for forwarding, over a network to at least one gateway, historical vehicular position services, said method comprising the steps of:
a. authenticating a subscriber;
b. receiving forwarded location information from at least one gateway over a network, said gateway forwarding said location information received from a vehicle, said vehicle equipped with a global positioning system (GPS) for identifying location information, a logging system for periodically collecting and storing location information, and a wireless network interface for communicating via the IEEE 802.11b protocol with said gateway;
c. identifying at least one historical vehicular position service based upon said received forwarded location information; and
d. offering said identified historical position service.

9. A method for forwarding, over a network to at least one gateway, historical vehicular position services, as per claim 8, wherein said historical vehicular position services comprises any of: notifications regarding maximum speed exceptions, notifications regarding acceptable routes or destinations, notifications of preventive maintenance, or tax oriented record keeping services.

10. A method for forwarding, over a network to at least one gateway, historical vehicular position services, as per claim 8, wherein communications between said gateway and said network-based service location are over any of the following networks: local area network (LAN), wide area network (WAN), wireless network, or the Internet.
